(19) United States
(12) Patent Application Publication
(10) Pub. No.: US 2008/0022893 A1
(43) Pub. Date: Jan. 31, 2008

(54) Dispersion and ink composition

(75) Inventor: Akira Mizutani, Matsumoto-shi (JP)

Correspondence Address: Clifford J. Mass;Ladas & Parry LLP, 26 West 61 Street, New York, NY, 10023, US

(73) Assignee: SEIKO EPSON CORPORATION

(21) Appl. No.: 11/703,208

(22) Filed: Feb. 6, 2007

(30) Foreign Application Priority Data
Feb. 7, 2006 (JP) P.2006-029298

(51) Int. Cl. C09D 11/00; B01F 3/12

(52) U.S. Cl. 106/31.25; 516/77

(57) ABSTRACT

An object of the present invention is to provide a dispersion useful for the preparation of a white ink composition having a high level of opacifying properties, and an ink composition obtained from the dispersion. The dispersion of the invention is a dispersion containing hollow polymer fine particles, wherein the hollow polymer fine particles comprise a plurality of fine particle subgroups, and the difference in average particle size between the respective fine particle subgroups adjacent to each other in terms of average particle size is less than 100 nm. The ink composition of the invention contains the dispersion.

### FIELD OF THE INVENTION

The present invention relates to a dispersion and an ink composition. The dispersion of the invention contains hollow polymer fine particles, so that it is useful for the preparation of a white ink composition. In particular, it is prepared by combining three or more kinds of hollow polymer fine particle subgroups different in average size, so that it is useful for the preparation of a white ink composition having a high level of opacifying properties.

### BACKGROUND OF THE INVENTION

It is known to use hollow polymer fine particles as a white coloring agent in a white ink composition for ink jet recording (for example, patent document 1). The hollow polymer fine particles described in the above-mentioned patent document 1 are spherical bodies having a cavity at the center of the fine particle and having an outside diameter of 1 μm or less, and are formed of a liquid-permeable polymer film. Accordingly, when present in an aqueous ink composition, the central cavity is filled with an aqueous medium. The hollow polymer fine particles filled with the aqueous medium have a specific gravity close to that of the aqueous medium, so that the problem of precipitation which occurs at the time when an inorganic pigment is used can be significantly solved to improve storage stability, ejection stability and the like of the ink composition. Further, when the ink composition containing the hollow polymer fine particles is ejected onto a medium such as recording paper, the aqueous medium is removed from the central cavity, leaving an airspace filled with air. The size of this airspace is designed so as to effectively scatter visible light. Accordingly, a white image can be formed on the medium.

In the above-mentioned patent document 1, there is specifically described an aqueous ink composition containing commercially available hollow polymer fine particles having an outside diameter of 500 nm, and it is shown that the composition is improved in opacity compared to an aqueous ink composition containing non-hollow polymer fine particles having an outside diameter of 500 nm.

It is also proposed to use hollow polymer fine particle groups having plural kinds of outside diameters (patent document 2). According to the description of the above-mentioned patent document 2, the hue of a white image can be controlled by using at least two kinds of hollow polymer fine particle groups different in outside diameter by 100 nm or more. Specifically, it is described that the hue as represented by the b value in the Lab method or the contribution of blue to the white image can be changed systematically and controllably by variously changing the mixing ratio of two kinds of hollow polymer fine particle groups, which are a small-sized hollow polymer fine particle group having an outside diameter of 320 nm and a large-sized hollow polymer fine particle group having an outside diameter of 900 nm.

Patent Document 1: U.S. Pat. No. 4,880,465

Patent Document 2: JP-A-2003-313481

### SUMMARY OF THE INVENTION

However, the opacifying properties according to the ink composition described in the above-mentioned patent document 1 are insufficient. Further, in the above-mentioned patent document 2, no reference is made at all to the effect to the opacifying properties by combining two or more hollow polymer fine particle groups having plural kinds of outside diameters. Furthermore, the above-mentioned patent document 2 merely discloses ink compositions prepared by combining hollow polymer fine particle groups having two kinds of outside diameters specifically. The present inventors have confirmed those specifically disclosed ink compositions by experiments. As a result, the opacifying properties were insufficient (see the “Examples” section below).

The present inventors have made extensive studies for improving the opacifying properties in an ink composition using hollow polymer fine particles as a white coloring agent. As a result, it has been found that it is possible to improve the opacifying properties by using three or more kinds of hollow polymer fine particle groups (fine particle subgroups).

In addition, a dispersion (particularly, an aqueous dispersion) containing three or more kinds of hollow polymer fine particle subgroups is first prepared, and the above-mentioned ink composition can be prepared from the dispersion (particularly, the aqueous dispersion).

The invention is based on such findings.

Other objects and effects of the invention will become apparent from the following description.

Accordingly, the invention relates to a dispersion containing hollow polymer fine particles, wherein the above-mentioned hollow polymer fine particles comprise a first fine particle subgroup having an average particle size of 200 to 400 nm, a second fine particle subgroup having an average particle size of 400 to 600 nm and a third fine particle subgroup having an average particle size of 900 to 1110 nm.

A preferred embodiment of the above-mentioned dispersion according to the invention is an aqueous dispersion.

Further, the invention relates to an ink composition (particularly, an aqueous ink composition) comprising the above-mentioned dispersion, and preferably relates to an ink composition (particularly, an aqueous ink composition) which is an ink for ink jet recording.

The dispersion of the invention contains three or more kinds of hollow polymer fine particle subgroups different in average particle size, and the ink composition prepared from this dispersion contains three or more kinds of hollow polymer fine particle subgroups different in average particle size, so that it can show a high level of opacifying properties.

### DETAILED DESCRIPTION OF THE INVENTION

The dispersion (particularly, the aqueous dispersion) according to the invention contains hollow polymer fine particles, and the hollow polymer fine particles comprise three or more kinds of fine particle subgroups. That is, the above-mentioned hollow polymer fine particles comprise at least three kinds of the following fine particle subgroups:

(1) a first fine particle subgroup having an average particle size of 200 to 400 nm;

(2) a second fine particle subgroup having an average particle size of 400 to 600 nm; and

(3) a third fine particle subgroup having an average particle size of 900 to 1110 nm.

Here, the average particle size of the above-mentioned first fine particle subgroup shall be smaller than the average particle size of the above-mentioned second fine particle subgroup.

There is preferably a difference of 100 to 400 nm and more preferably a difference of 100 to 300 nm, between the average particle size of the above-mentioned first fine particle subgroup and the average particle size of the above-mentioned second fine particle subgroup. Further, there is preferably a difference of 300 to 700 nm and more preferably a difference of 350 to 550 nm, between the average particle size of the above-mentioned second fine particle subgroup and the average particle size of the above-mentioned third fine particle subgroup. Furthermore, there is preferably a difference of 500 to 900 nm and more preferably a difference of 500 to 700 nm, between the average particle size of the above-mentioned first fine particle subgroup and the average particle size of the above-mentioned third fine particle subgroup.

In this specification, the particle size or average particle size means the particle size or average particle size measured with a particle size distribution measuring device the measuring principle of which is based on the laser diffraction scattering method. As a typical laser diffraction type particle size distribution measuring device, there can be used, for example, a particle size analyzer (for example, “Microtruck UPA” manufactured by Nikkiso Co., Ltd.) the measuring principle of which is based on the dynamic light scattering method (FFT power spectrum method).

The dispersion according to the invention can be prepared by combining the three kinds of hollow polymer fine particle subgroups having different particle sizes satisfying the above-mentioned conditions (that is, the above-mentioned first fine particle subgroup, the above-mentioned second fine particle subgroup and the above-mentioned third fine particle subgroup), and additionally using a hollow polymer fine particle subgroup having another average particle size in some cases.

A preparation method of the hollow polymer fine particles used in the invention is not particularly limited, and various known methods can be used. For example, they are described in the above-mentioned patent document 1 or 2, and further, in each specification of U.S. Pat. Nos. 5,229,209, 4,594,363, 4,427,836 or 4,089,800. Further, various hollow polymer fine particles are commercially available. Furthermore, the preparation method of the above-mentioned hollow polymer fine particles and a designing method of the cavity size or the outside diameter are also known, and described, for example, in the above-mentioned respective documents. The above-mentioned hollow polymer fine particles are typically prepared according to an ordinary emulsion polymerization technique, and contain an ordinary surfactant. In addition, the individual hollow polymer fine particles are dispersed in an aqueous medium, an organic/water-mixed medium or an organic medium, thereby being able to prepare as a stable dispersion system. Good dispersibility is imparted to the dispersion thus obtained without necessitating a pulverization operation or a grinding operation which is necessary in preparing an ordinary pigment ink composition, and the dispersion can be utilized, for example, in the preparation of an ink composition for ink jet recording.

Vinyl monomers which can be used in the preparation of the above-mentioned hollow polymer fine particles include, for example, nonionic monoethylene unsaturated monomers, and the nonionic monoethylene unsaturated monomers include, for example, styrene, vinyltoluene, ethylene, vinyl acetate, vinyl chloride, vinylidene chloride, acrylonitrile, (meth)acrylamide, and various esters of (meth)acrylic acid such as methyl acrylate (MA), methyl methacrylate (MMA), ethyl acrylate (EA) or butyl acrylate (BA), for example, (C₁-C₂₀)alkyl or (C₃-C₂₀)alkenyl esters. Further, as the (meth)acrylic ester, there can also be used, for example, methyl methacrylate (MMA), methyl acrylate (MA), ethyl (meth)acrylate (EMA), butyl(meth)acrylate (BMA), 2-hydroxyethyl methacrylate (HEMA), 2-ethylhexyl(meth)acrylate (EHMA), benzyl(meth)acrylate, lauryl(meth)acrylate, oleyl(meth)acrylate, palmityl(meth)acrylate or stearyl(meth)acrylate.

It is also possible to form an outer shell (polymer film) by copolymerizing a bifunctional vinyl monomer, for example, divinylbenzene, allyl methacrylate, ethylene glycol dimethacrylate, 1,3-butanediol dimethacrylate, diethylene glycol dimethacrylate or trimethylolpropane trimethacrylate, to perform crosslinking.

The dispersion medium for the hollow polymer fine particles used in the invention is an aqueous dispersion medium, an organic/water mixed dispersion medium or an organic dispersion medium, particularly an aqueous dispersion medium or an organic/water mixed dispersion medium, for example, water or water containing a hydrophilic organic solvent. Further, the surfactants used in emulsion polymerization include, for example, an anionic surfactant, a nonionic surfactant, a cationic surfactant, an amphoteric surfactant, an organic suspension protective agent and the like.

In the dispersion according to the invention, the content (solid content) of the hollow polymer fine particles is not particularly limited. For example, however, it is preferably form 10 to 90% by weight, and more preferably from 20 to 80% by weight, based on the total weight of the above-mentioned dispersion. Further, the mixing ratio of the individual hollow polymer fine particle subgroups contained in the dispersion of the invention is also not particularly limited as long as the opacifying properties of an ink composition prepared from this dispersion can be well expressed. For example, the contents of the above-mentioned first fine particle subgroup and the above-mentioned third fine particle subgroup can be each mutually independently a 1/10 to 10-fold excess in relation to the content of the above-mentioned second fine particle subgroup. Further, the individual solid contents of the above-mentioned first fine particle subgroup, the above-mentioned second fine particle subgroup and the above-mentioned third fine particle subgroup may be 5% by weight based on the total solid content of the mixed hollow polymer fine particles.

The ink composition according to the invention can be prepared from the above-mentioned dispersion by a known method. The ink composition of the invention may contain various known additives, in addition to the above-mentioned hollow polymer fine particles and the above-mentioned aqueous dispersion medium. As the additives, there can be used ordinary additives contained in an ordinary ink composition. In particular, when an ink composition for ink jet recording is prepared, additives ordinarily used in the preparation of an ink composition for ink jet recording can be used.

In the ink composition of the invention, the content of the above-mentioned hollow polymer fine particles is not particularly limited, as long as the opacifying properties can be well expressed. For example, however, it is preferably form 5 to 90% by weight, and more preferably from 10 to 80% by weight, based on the total weight of the above-mentioned ink composition. In addition, the mixing ratio of the individual hollow polymer fine particle subgroups contained in the ink composition of the invention is the same as the mixing ratio in the above-mentioned dispersion.

The ink composition of the invention can be imparted as a white ink to any recording medium. As for the recording medium, the ink composition can be imparted, for example, to a medium such as paper, cardboard, a textile product (for example, a woven fabric), a natural or synthetic sheet or film, plastic, glass or ceramic. Further, the ink composition of the invention can be applied to any printing system, and can be utilized, for example, by various printers of a thermal ink jet, a piezoelectric ink jet, a continuous ink jet, roller application, spray application and the like.

### EXAMPLES

The present invention will be illustrated in grater detail with reference to the following Examples and Comparative Examples, but the invention should not be construed as being limited to the Examples. The parts and % used in the Examples and Comparative Examples are given by weight unless otherwise indicated.

<Production Method of Hollow Polymer Fine Particle Emulsions>

(1) Polymer Particles 1

In a 2-liter reaction vessel were placed 80 parts of styrene, 5 parts of methacrylic acid, 15 parts of methyl methacrylate, 1 part of an α-methylstyrene dimer, 14 parts of t-dodecylmercaptan, 0.8 part of sodium dodecylbenzene-sulfonate, 1.0 part of potassium persulfate and 200 parts of water, followed by stirring in a nitrogen gas. The resulting mixture was heated to 80° C., and emulsion polymerization was conducted for 6 hours. Polymer particles 1 obtained thereby had an average particle size of 0.15 μm.

(2) Hollow Polymer Fine Particle Emulsion 1

Together with 10 parts (in terms of solid content) of polymer particles 1 obtained in the above section (1), 0.3 part of sodium laurylsulfate, 0.5 part of potassium persulfate and 400 parts of water were placed in a reaction vessel, and a crosslinking polymerizable monomer composition comprising a mixture of 11.6 parts (purity: 55% by weight, remainder: a monofunctional vinyl monomer) of divinylbenzene, 8.4 parts of ethylvinylbenzene, 5 parts of acrylic acid and 75 parts of methyl methacrylate was added thereto, followed by stirring at 30° C. for 1 hour. Then, emulsion polymerization treatment was conducted with further stirring at 70° C. for 5 hours to obtain an aqueous dispersion. The resulting one was measured with a particle size analyzer (Microtruck UPA: Nikkiso Co., Ltd.). As a result, the particle size of the dispersed fine particles was 320 nm. Separately, the particles were observed under a transmission electron microscope. As a result, they were hollow polymer fine particles. The emulsion thus obtained is taken as hollow polymer fine particle emulsion 1.

(3) Hollow Polymer Fine Particle Emulsions 2 to 4 and 6

Hollow polymer fine particle emulsions 2 to 4 and 6 were obtained in the same manner as in the above section (1) “Hollow polymer fine particle Emulsion 1” with the exception that polymer particles 1 to 4 obtained by compositions shown in Table 1 and compositions shown in Table 2 were used.

(4) Hollow Polymer Fine Particle Emulsion 5

A reaction vessel was charged with 2 parts of polymer particles 1, 20 parts of polyvinyl alcohol, 2 parts of a polymerization initiator, 3,5,5-trimethylhexanoyl peroxide, and 500 parts of water, and a mixture of a crosslinking polymerizable monomer composition comprising a mixture of 25 parts of ethylene dimethacrylate, 5 parts of methacrylic acid and 70 parts of methyl methacrylate and 400 parts of toluene was added thereto, followed by stirring at 40° C. for 2 hours. Then, emulsion polymerization treatment was conducted with further stirring at 70° C. for 15 hours to obtain an aqueous dispersion. The emulsion thus obtained is taken as hollow polymer fine particle emulsion 5.

TABLE 1

Polymer Particles

| Composition (parts) | 1 | 2 | 3 | 4 |
|---|---|---|---|---|
| Styrene | 80 | 80 | 80 | 100 |
| Methyl Methacrylate | 15 | 15 | 7 | |
| Methacrylic Acid | 5 | 5 | | |
| Acrylonitrile | | | 8 | |
| Acrylic Acid | | | 5 | |
| α-Methylstyrene Dimer | 1 | 2 | 1 | 1 |
| Average Particle Size (nm) | 150 | 200 | 550 | 250 |

TABLE 2

| | | Hollow Polymer Fine Particle Emulsion | | | | | |
|---|---|---|---|---|---|---|---|
| | | 1 | 2 | 3 | 4 | 5 | 6 |
| Polymer | Kind | 1 | 2 | 1 | 4 | 1 | 3 |
| Particles | Amount Used (parts) | 10 | 10 | 5 | 10 | 2 | 10 |
| Monomers | Divinylbenzene | 11.6 | 11.6 | 11.6 | 11.6 | | 11.6 |
| | Ethylene Glycol Dimethacrylate | | | | | 25 | |
| | Styrene | 5 | 5 | 5 | | | 5 |
| | Ethylvinylbenzene | 8.4 | 8.4 | 8.4 | 8.4 | | 8.4 |
| | Acrylic Acid | 5 | | 5 | | | |
| | Methacrylic Acid | | 5 | | 5 | 5 | 5 |
| | Methyl Methacrylate | 75 | 75 | 75 | 75 | 70 | 75 |

| | | | | | | |
|---|---|---|---|---|---|---|
| Particle Size (nm) | 320 | 400 | 460 | 520 | 920 | 1000 |

The above-mentioned aqueous dispersions were each prepared so as to give a solid content of 25%, and ink compositions 1 to 4 according to the invention (Examples 1 to 4) and ink compositions 1 and 2 for comparison (Comparative Examples 1 and 2) were prepared as shown below by using the resulting hollow polymer fine particle emulsions in various combinations.

### Example 1

| | |
|---|---|
| Hollow polymer fine particle emulsion 1 | 26% by weight |
| (particle size: 320 nm, solid content: 25.0%) | |
| Hollow polymer fine particle emulsion 3 | 27% by weight |
| (particle size: 460 nm, solid content: 25.0%) | |
| Hollow polymer fine particle emulsion 5 | 27% by weight |
| (particle size: 920 nm, solid content: 25.0%) | |
| Glycerol | 10% by weight |
| BYK 348 (silicone-based surfactant | 0.3% by weight |
| manufactured by BYK Chemie Japan) | |
| Triethanolamine | 0.9% by weight |
| Pure water | balance |

### Example 2

| | |
|---|---|
| Hollow polymer fine particle emulsion 2 | 26% by weight |
| (particle size: 400 nm, solid content: 25.0%) | |
| Hollow polymer fine particle emulsion 4 | 27% by weight |
| (particle size: 520 nm, solid content: 25.0%) | |
| Hollow polymer fine particle emulsion 6 | 27% by weight |
| (particle size: 1000 nm, solid content: 25.0%) | |
| Glycerol | 10% by weight |
| BYK 348 (silicone-based surfactant | 0.3% by weight |
| manufactured by BYK Chemie Japan) | |
| Triethanolamine | 0.9% by weight |
| Pure water | balance |

### Example 3

| | |
|---|---|
| Hollow polymer fine particle emulsion 1 | 20% by weight |
| (particle size: 320 nm, solid content: 25.0%) | |
| Hollow polymer fine particle emulsion 3 | 20% by weight |
| (particle size: 460 nm, solid content: 25.0%) | |
| Hollow polymer fine particle emulsion 5 | 40% by weight |
| (particle size: 920 nm, solid content: 25.0%) | |
| Glycerol | 10% by weight |
| BYK 348 (silicone-based surfactant | 0.3% by weight |
| manufactured by BYK Chemie Japan) | |
| Triethanolamine | 0.9% by weight |
| Pure water | balance |

### Example 4

| | |
|---|---|
| Hollow polymer fine particle emulsion 2 | 20% by weight |
| (particle size: 400 nm, solid content: 25.0%) | |
| Hollow polymer fine particle emulsion 4 | 20% by weight |
| (particle size: 520 nm, solid content: 25.0%) | |
| Hollow polymer fine particle emulsion 6 | 40% by weight |
| (particle size: 1000 nm, solid content: 25.0%) | |
| Glycerol | 10% by weight |
| BYK 348 (silicone-based surfactant | 0.3% by weight |
| manufactured by BYK Chemie Japan) | |
| Triethanolamine | 0.9% by weight |
| Pure water | balance |

### Comparative Example 1

| | |
|---|---|
| Hollow polymer fine particle emulsion 1 | 40% by weight |
| (particle size: 320 nm, solid content: 25.0%) | |
| Hollow polymer fine particle emulsion 5 | 40% by weight |
| (particle size: 920 nm, solid content: 25.0%) | |
| Glycerol | 10% by weight |
| BYK 348 (silicone-based surfactant | 0.3% by weight |
| manufactured by BYK Chemie Japan) | |
| Triethanolamine | 0.9% by weight |
| Pure water | balance |

### Comparative Example 2

| | |
|---|---|
| Hollow polymer fine particle emulsion 2 | 40% by weight |
| (particle size: 400 nm, solid content: 25.0%) | |
| Hollow polymer fine particle emulsion 6 | 40% by weight |
| (particle size: 1000 nm, solid content: 25.0%) | |
| Glycerol | 10% by weight |
| BYK 348 (silicone-based surfactant | 0.3% by weight |
| manufactured by BYK Chemie Japan) | |
| Triethanolamine | 0.9% by weight |
| Pure water | balance |

<<Evaluation of Opacifying Properties>>

Black monochromatic solid printing was performed on photo mat paper (used exclusively for pigments; manufactured by Seiko Epson Corporation) with an ink jet printer (PX-A550; manufactured by Seiko Epson Corporation). Aside from this, the six kinds of ink compositions prepared in the above-mentioned Examples 1 to 4 and Comparative Examples 1 and 2 were each printed on an OHP sheet (Epson exclusive paper; manufactured by Seiko Epson Corporation) with the above-mentioned ink jet printer (PX-A550). The white printed OHP sheet was superposed on the black printed photo mat paper, and the Db value (density of black; OD value) and the L*a*b* value were measured. Gretag Macbeth SPM50 (manufactured by Gretag Macbeth) was used as a measuring device. The results of measurement are shown in Table 3. Reference Example shows a measured value for only the black printed photo mat paper without superposing the white printed OHP sheet.

TABLE 3

| | Db | L* | a* | b* |
|---|---|---|---|---|
| Example 1 | 0.21 | 81.21 | −2.15 | −5.8 |
| Example 2 | 0.22 | 80.48 | −2.36 | −6.62 |
| Example 3 | 0.20 | 84.66 | −1.99 | −5.12 |
| Example 4 | 0.18 | 86.03 | −1.79 | −4.48 |
| Comparative Example 1 | 0.45 | 70.91 | −5.2 | −12.47 |
| Comparative Example 2 | 0.42 | 68.15 | −0.49 | −3.84 |
| Reference Example (only Bk) | 1.96 | 9.56 | −0.63 | −3.26 |

The dispersion of the invention contains the hollow polymer fine particles, so that it is useful for the preparation of the white ink composition, and particularly, it is prepared by combining the hollow polymer fine particle subgroups having a plurality of average particle sizes, so that it is useful for the preparation of the white ink composition having a high level of opacifying properties.

The ink composition of the invention contains hollow polymer fine particles, so that it can be used as the white ink composition, and particularly, it contains the hollow polymer fine particle subgroups having a plurality of average particle sizes in combination, so that it can be suitably used for applications requiring a high level of opacifying properties.

While the present invention has been described in detail and with respect to specific embodiments thereof, it will be apparent to one skilled in the art that various changes and modifications can be made therein without departing from the spirit and scope thereof.

This application is based on Japanese Patent Application No. 2006-029298 filed Feb. 7, 2006, and the contents thereof is herein incorporated by reference.

1. A dispersion containing hollow polymer fine particles, wherein the hollow polymer fine particles comprise a first fine particle subgroup having an average particle size of 200 to 400 nm, a second fine particle subgroup having an average particle size of 400 to 600 nm and a third fine particle subgroup having an average particle size of 900 to 1110 nm.

2. The dispersion according to claim 1, wherein the dispersion is aqueous.

3. An ink composition comprising the dispersion according to claim 1.

4. An ink composition comprising the dispersion according to claim 2.
